(19) United States
(12) Patent Application Publication
(10) Pub. No.: US 2026/0147362 A1
(43) Pub. Date: May 28, 2026

(54) Picking System, Picking Control Device, Conveying Device, Conveying System, Picking Control Program, Conveying Method, and Conveying Program

(71) Applicant: Softbank Group Corp., Tokyo (JP)

(72) Inventor: Masayoshi Son, Minato-ku, Tokyo (JP)

(21) Appl. No.: 19/122,193

(22) PCT Filed: Oct. 17, 2023
(86) PCT No.: PCT/JP2023/037598

§ 371 Date: Apr. 17, 2025

(30) Foreign Application Priority Data
Oct. 20, 2022 (JP) 2022-168242
Nov. 25, 2022 (JP) 2022-188746
Nov. 25, 2022 (JP) 2022-188747
Dec. 2, 2022 (JP) 2022-193778
Dec. 28, 2022 (JP) 2022-212507

(51) Int. Cl. G05D 1/667; B65G 1/137; G05D 1/65; G05D 1/689; G05D 1/69; G05D 105/20; G05D 107/70; G05D 109/10

(52) U.S. Cl. CPC G05D 1/667; B65G 1/1373; G05D 1/65; G05D 1/6895; G05D 1/69; B65G 2203/0208; B65G 2203/0283; B65G 2203/0291; G05D 2105/20; G05D 2107/70; G05D 2109/10

(57) ABSTRACT

A picking system includes: a first cart including a first arm and traveling along a first lane set outside of an accommodation unit that accommodates a load; a second cart including a second arm and traveling along a second lane set outside of the first lane; and a control unit configured to perform control such that the first cart picks up the load using the first arm and transfers the load to the second cart while traveling along the first lane, and the second cart receives the load picked up by the first cart using the second arm and carries the load to a predetermined position while traveling along the second lane.

### TECHNICAL FIELD

The present disclosure relates to a picking system, a picking control device, a conveying device, a conveying system, a picking control program, a conveying method, and a conveying program.

### BACKGROUND ART

Patent Literature 1 discloses a picking device that conveys articles in a management zone. The picking device includes a robot that autonomously moves a plurality of shelves disposed in the management zone based on a predetermined pickup plan of the articles, picks up and returns the articles from and to the shelves, and conveys the articles to a predetermined picking station.

### CITATION LIST

### Patent Literature

Patent Literature 1: Japanese Patent Application Laid-Open (JP-A) No. 2022-068557

### SUMMARY OF INVENTION

### Technical Problem

When a cart is caused to autonomously travel to pick up a load in a warehouse and carry the load to a predetermined position, efficiency is poor if one cart is responsible for picking a load and carrying the load to the predetermined position. In order for a cart to autonomously travel (hereinafter referred to as “automatic driving”), it is expensive to mount all sensors detecting surroundings information of the cart on one cart.

The present disclosure has been made in view of the above circumstances, and an object of the disclosure is to provide a picking system, a picking control device, a conveying device, a conveying system, a picking control program, a conveying method, and a conveying program capable of efficiently picking and conveying a load.

### Solution to Problem

According to the disclosed technology, a picking system includes: a first cart including a first arm and traveling along a first lane set outside of an accommodation unit that accommodates a load; a second cart including a second arm and traveling along a second lane set outside of the first lane; and a picking control unit configured to perform control such that the first cart picks up the load using the first arm and transfers the load to the second cart while traveling along the first lane, and the second cart receives the load picked up by the first cart using the second arm and carries the load to a predetermined position while traveling along the second lane.

The picking control unit may perform control such that the load is transferred from the first cart to the second cart while the first cart and the second cart travel in parallel.

The picking system may further include a generation unit configured to generate a traveling path of the first cart based on a position of the load to be picked up by the first cart and a position of the second cart to which the load picked up by the first cart is to be transferred. Based on the traveling path, the picking control unit may perform control such that the first cart picks up the load using the first arm and transfers the load to the second cart while traveling along the first lane, and the second cart receives the load picked up by the first cart using the second arm and carries the load to a predetermined position while traveling along the second lane. The generation unit may generate the traveling path based on an order of transferring the load to the second cart. The generation unit may generate the traveling path based on a size of the load.

The picking control unit may perform control such that the load is transferred from the first cart to the second cart by setting a position at which speeds of the first cart and the second cart become equal and a distance between the first cart and the second cart is minimum as a transfer position. The transfer position may be a position within a range in which a movement range of the first arm overlaps a movement range of the second arm.

The second cart may include a storage unit. The picking control unit may perform control such that the first cart picks up the load using the first arm while traveling along the first lane and transfers the load to the second cart, the second cart receives the load picked up by the first cart using the second arm while traveling along the second lane and stores the load in the storage unit, and when a storage amount of the storage unit reaches a certain level, the second cart departs from the second lane and a new second cart is supplied. When a plurality of the second carts travel along the second lane at equal intervals and the new second cart cannot be supplied, the picking control unit may perform control to increase an inter-vehicle distance of each of the plurality of second carts and cause the plurality of second carts to travel at equal intervals.

A picking control device according to the disclosed technology includes: a picking control unit configured to perform control such that a first cart including a first arm and traveling along a first lane set outside of an accommodation unit that accommodates a load picks up the load using the first arm while traveling along the first lane and transfers the load to a second cart, and a second cart including a second arm and traveling along a second lane set outside of the first lane receives the load picked up by the first cart using the second arm while traveling along the second lane and carries the load to a predetermined position.

The picking control device may further include a generation unit configured to generate a traveling path of the first cart based on a position of the load to be picked up by the first cart and a position of the second cart to which the load picked up by the first cart is to be transferred. Based on the traveling path, the picking control unit may perform control such that the first cart picks up the load using the first arm and transfers the load to the second cart while traveling along the first lane, and the second cart receives the load picked up by the first cart using the second arm and carries the load to a predetermined position while traveling along the second lane.

The picking control unit may perform control such that a second cart including a storage unit receives the load picked up by the first cart using the second arm while traveling along the second lane and stores the load in the storage unit, and when a storage amount of the storage unit reaches a certain level, the second cart departs from the second lane and a new second cart is supplied.

A conveying device according to the disclosed technology includes an accommodation unit accommodating a load, an arm operating the load, and a first sensor detecting external information. The conveying device includes an acquisition unit configured to acquire information regarding the first sensor mounted on another conveying device; and a control unit configured to perform control such that automatic driving is performed using sensor information of the first sensor acquired in addition to sensor information of the first sensor mounted on the own device.

One of a plurality of types of devices including a camera that images outside and a LiDAR that measures the outside may be mounted as the first sensor. The acquisition unit may acquire sensor information of a second sensor provided in an area where the conveying device travels. The control unit may perform control such that automatic driving is performed using the sensor information of the second sensor in addition to the sensor information of the first sensor. The acquisition unit may acquire sensor information of a third sensor mounted on a flight vehicle that flies in an area where the conveying device travels. The control unit may perform control such that automatic driving is performed using sensor information of the third sensor in addition to sensor information of the first sensor.

The conveying system according to the disclosed technology includes a plurality of the above-described conveying devices. In the conveying system, the plurality of conveying devices each include a first cart that travels along a first lane and a second cart that travels along a second lane adjacent to the first lane The first cart picks up the load using the arm of the first cart while traveling along the first lane. The second cart receives and carries the load picked up by the first cart using the arm of the second cart while traveling.

A picking control program according to the disclosed technology is a program causing a computer to perform a process including control performed such that a first cart including a first arm and traveling along a first lane set outside of an accommodation unit that accommodates a load picks up the load using the first arm while traveling along the first lane and transfers the load to a second cart, and a second cart including a second arm and traveling along a second lane set outside of the first lane receives the load picked up by the first cart using the second arm while traveling along the second lane and carries the load to a predetermined position.

The picking control program may cause the computer to perform a process including control performed such that a traveling path of the first cart is generated based on a position of the load to be picked up by the first cart and a position of the second cart to which the load picked up by the first cart is to be transferred, and the first cart picks up the load using the first arm and transfers the load to the second cart while traveling along the first lane based on the traveling path, and the second cart receives the load picked up by the first cart using the second arm and carries the load to a predetermined position while traveling along the second lane.

The picking control program may cause the computer to perform a process including control performed such that the first cart picks up the load using the first arm and transfers the load to the second cart while traveling along the first lane, the second cart having a storage unit receives the load picked up by the first cart using the second arm while traveling along the second lane and stores the load in the storage unit, and when a storage amount of the storage unit reaches a certain level, the second cart departs from the second lane and a new second cart is supplied.

A conveying method according to the disclosed technology is a method of a conveying device including an accommodation unit that accommodates a load, an arm that operates the load, and a first sensor that detects external information. The conveying method causes a computer to perform: acquiring information regarding the first sensor mounted on another conveying device; and performing control such that automatic driving is performed using sensor information of the first sensor acquired in addition to sensor information of the first sensor mounted on the own device.

A conveying program according to the disclosed technology is a program controlling a conveying device including an accommodation unit that accommodates a load, an arm that operates the load, and a first sensor that detects external information. The conveying program causes a computer to perform: acquiring information regarding the first sensor mounted on another conveying device; and performing control such that automatic driving is performed using sensor information of the first sensor acquired in addition to sensor information of the first sensor mounted on the own device.

### BRIEF DESCRIPTION OF DRAWINGS

FIG. 1 is a plan view illustrating a floor of a warehouse to which a picking system is applied.

FIG. 2 is a perspective view illustrating a cart robot.

FIG. 3 is a perspective view illustrating a state in which a basket is transferred from a local cart to a high-speed cart.

FIG. 4A is a flowchart illustrating pickup control processing of a basket by the local cart.

FIG. 4B is a flowchart illustrating pickup control processing of the basket by the high-speed cart.

FIG. 5 is a diagram schematically illustrating an example of a functional configuration of the cart robot.

FIG. 6 is a diagram illustrating a hardware configuration of a picking control device.

FIG. 7 is a flowchart illustrating picking control processing.

FIG. 8 is a diagram schematically illustrating an example of a configuration in which sensor information is acquired.

FIG. 9 is a diagram schematically illustrating an example of a functional configuration of an information processing apparatus.

FIG. 10 is a flowchart illustrating automatic driving control of the cart robot.

FIG. 11 is a diagram schematically illustrating an example of computer hardware functioning as an information processing apparatus of a cart robot.

### DESCRIPTION OF EMBODIMENTS

Hereinafter, the present invention will be described in embodiments of the disclosed technology, but the following embodiments do not limit the invention according to the claims. Not all combinations of features described in the embodiments are essential to the solution of the invention.

### First Embodiment

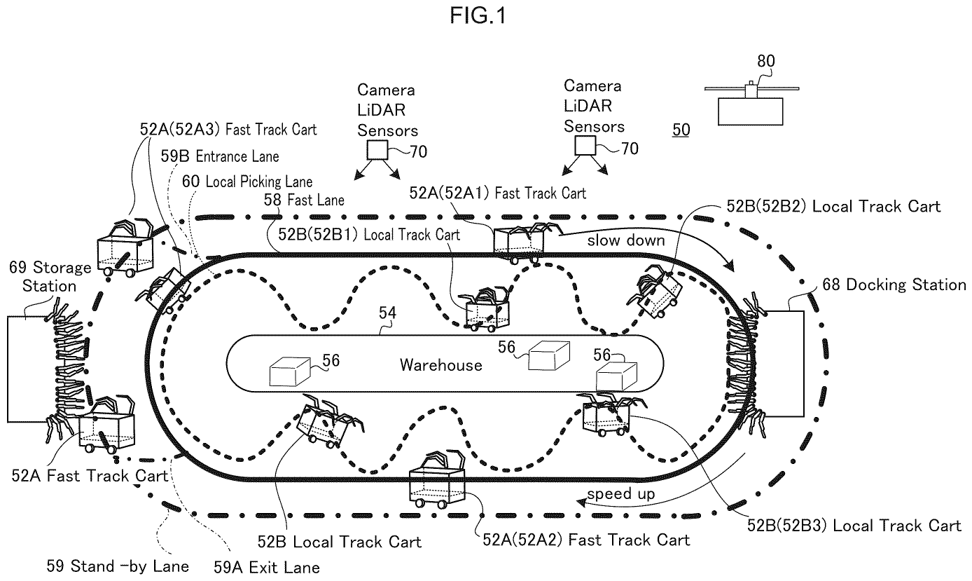

FIG. 1 is a plan view of a floor 50 of a warehouse to which a picking system according to the present embodiment is applied. Picking work is work for collecting (picking up) necessary items. Picking staffs (in the present embodiment, cart robots 52) are located in warehouses of all genres since the picking staffs have essential roles in shipping items in warehouses. Not only the cart robots but also humanoid robots may be used.

For example, a main job is to collect designated items based on a list or an order instructed in advance and to deliver the collected items to an inspection person or a packing person. The larger a size of the warehouse is, the larger the number of types and the number of stored items are. Therefore, many picking staffs move within the floor 50.

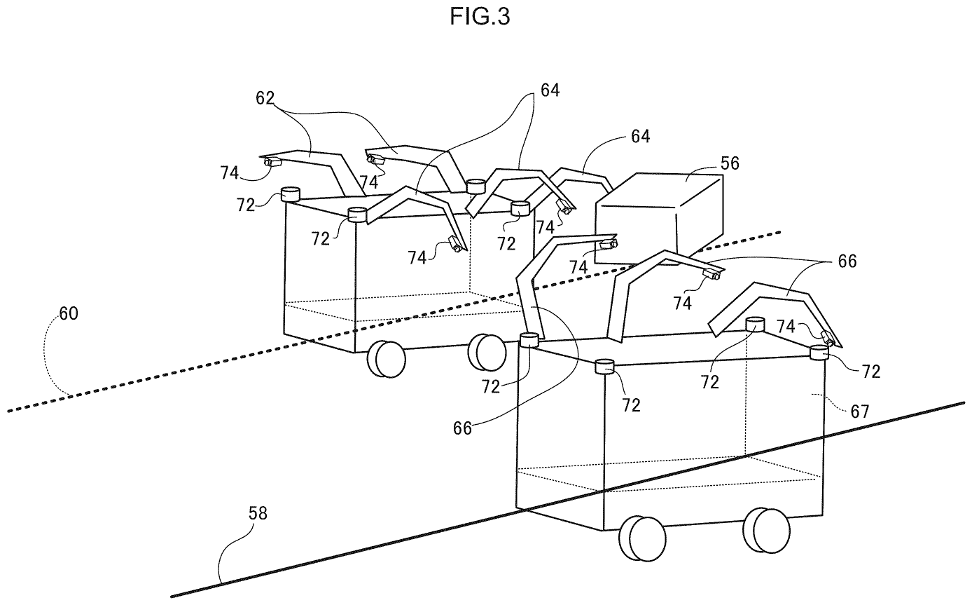

On the floor 50 illustrated in FIG. 1, a storage unit (a warehouse, shelves, and the like) 54 is provided to store a plurality of baskets 56 (see FIG. 3). The cart robot 52 moves around the storage unit 54. The cart robots 52 mainly play a role of exchanging the baskets 56 and are classified into a fast track cart 52A (high-speed cart 52A) serving as the cart robot 52 that moves along a fast lane 58 (high-speed lane 58) and a local track cart 52B (local cart 52B) serving as the cart robot 52 that moves along a local picking lane 60 (local lane 60) as the movement route.

The storage unit 54 is an example of an accommodation unit according to the present disclosure. The local lane 60 is an example of a first lane according to the present disclosure. The high-speed lane 58 is an example of a second lane according to the present disclosure. The local cart 52B is an example of a first cart according to the present disclosure. The high-speed cart 52A is an example of a second cart according to the present disclosure.

The local lane 60 is a lane inside the floor 50, in other words, a lane set outside of the storage unit 54. The local cart 52B picks up the basket 56 from the storage unit 54 while meandering toward and away from the storage unit 54 and temporarily decelerating.

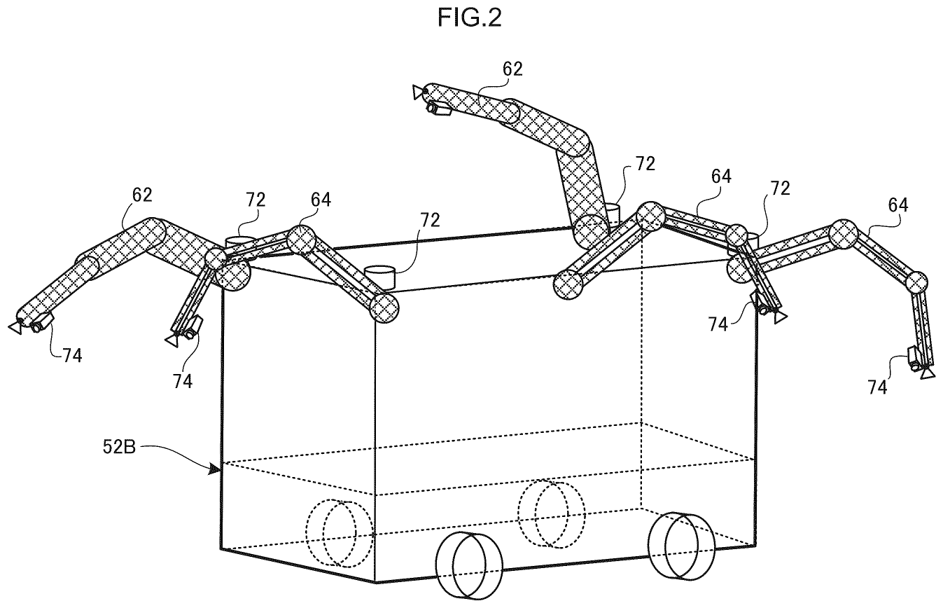

As illustrated in FIG. 2, the local cart 52B picks up the basket containing a load using two picking arms 62 (picking arm) provided inside, and then passes the basket 56 to the high-speed cart 52A moving along the high-speed lane 58 using three passing arms 64 (passing arm) provided outside. The picking arm 62 and the passing arm 64 are examples of the first arm. The local cart 52B incorporates a counter balance battery (not illustrated) for preventing falling.

The high-speed lane 58 is a lane outside of the floor 50, in other words, a lane set outside of the local lane 60. As illustrated in FIG. 3, for example, the high-speed cart 52A receives the basket 56 using three receiving arms 66 (receiving arm) from the local cart 52B traveling nonstop at 20 km/h and moving along the local lane 60. The receiving arms 66 are examples of the second arm. The high-speed cart 52A includes a storage unit 67 that stores the received basket 56.

As a series of operations, after picking up the basket 56, the local cart 52B traveling along the local lane 60 transfers the basket 56 to the high-speed cart 52A by using the three passing arms 64 (passing arm) of the local cart 52B and the three receiving arms 66 (receiving arm) of the high-speed cart 52A in a nonstop manner while traveling in parallel with the high-speed cart 52A in a manner of transferring a relay baton at a speed of 20 km/h with the outer high-speed lane 58. The high-speed cart 52A stores the received basket 56 in the storage unit 67 using the three receiving arms 66.

On the floor 50, a docking station 68 is installed to correspond to the storage unit 54. The position of the docking station 68 is an example of a predetermined position according to the present disclosure. The docking station 68 is a junction point between the high-speed lane 58 and the local lane 60. The docking station 68 includes twenty arms and has a function of receiving the baskets 56 from the high-speed lane 58. In the docking station 68, the high-speed cart 52A temporarily decelerates to, for example, 2 Km per hour, and, for example, transfers the basket within 1 minute, and accelerates again.

On the floor 50, a storage station 69 is installed to correspond to the storage unit 54. The position of the storage station 69 is also an example of a predetermined position according to the present disclosure, similarly to the docking station 68. The storage station 69 is a junction point with the standby lane 59 set outside of the high-speed lane 58. Like the docking station 68, the storage station 69 includes twenty arms and has a function of receiving the baskets 56 from the standby lane 59.

The standby lane 59 is connected to an exit lane 59A provided at a position farther away from the docking station 68 and branched from the high-speed lane 58. An entrance lane (entrance lane 59B) branched from the standby lane 59 is connected to the high-speed lane 58. The exit lane 59A is a lane that departs from the high-speed lane 58 to the standby lane 59, and the entrance lane 59B is a lane that enters the high-speed lane 58 from the standby lane 59. The number of provided exit lanes 59 A and the number of provided entrance lanes 59B may be plural.

In the storage station 69, the high-speed cart 52A decelerating from the exit lane 59A and departing to the standby lane 59 transfers the basket 56 within 1 minute and stands by before the entrance lane 59B. The high-speed cart 52A that has emptied the inside of the storage unit 67 standing by earlier before the entrance lane 59B enters the high-speed lane 58 from the entrance lane 59B when another high-speed cart 52A departs from the exit lane 59A to the standby lane 59. The high-speed cart 52A departs to the standby lane 59 when the storage amount of the basket 56 in the storage unit 67 reaches a certain level by a vehicle body sensor group 72 to be described below.

In the present embodiment, as an example, when the storage amount of the basket 56 in the storage unit 67 of the high-speed cart 52A reaches a certain level before reaching of the docking station 68, a new high-speed cart 52A is supplied instead of the high-speed cart 52A. Accordingly, since the high-speed cart 52A traveling along the high-speed lane 58 can normally receive the basket 56 from the local cart 52B, it is possible to efficiently pick and carry the load.

On the floor 50, an in-warehouse sensor group 70 including a camera and LiDAR are installed on a ceiling or a wall. The in-warehouse sensor group 70 is normally used as information for measuring an inter-vehicle distance between the high-speed cart 52A and the local cart 52B and speeds and synchronizing these carts with each other. The vehicle body sensor group 72 including a camera and a LiDAR is installed in each vehicle body (cart body) of the high-speed cart 52A and the local cart 52B. It is possible to perform prediction for providing a necessary inter-vehicle distance (for example, 3 m or more) by performing control such that the inter-vehicle distance is equal by division of the number of carts.

For example, when one high-speed cart 52A departs from the high-speed lane 58 to the standby lane 59 and a new high-speed cart 52A cannot be supplied, the inter-vehicle distance is controlled such that the inter-vehicle distance is equal by the division of the number of carts excluding the departing high-speed cart 52A. That is, control is performed such that the inter-vehicle distance between the high-speed carts 52A traveling along the high-speed lane 58 increases. Accordingly, even after the number of high-speed carts 52A is reduced, prediction for providing the necessary inter-vehicle distance can be made. The vehicle body sensor group 72 of the high-speed cart 52A also detects a storage amount of the basket 56 in the storage unit 67.

In the picking system, since the high-speed cart and the local cart 52B on the floor 50 perform work at a completely synchronized tempo, an accident such as interference (contact or collision) does not arise. To perform the picking work without stopping, time loss can be minimized as much as possible.

Here, the cart (the high-speed cart 52A and the local cart 52B) according to the present embodiment includes a plurality of arms as described above. The local cart 52B includes two picking arms 62 and three passing arms 64. The high-speed cart 52A includes three receiving arms 66. Hereinafter, the arms are collectively referred to as arms 62, 64, and 66. Since the arms 62, 64, and 66 move in three dimensions based on work such as picking of the basket 56 and transfer between carts, the arms cross a monitoring region of the vehicle body sensor group 72 installed in the cart body. With this three-dimensional movement, a blind area may occur in any of the vehicle body sensor groups 72. The arms 62, 64, and 66 move irregularly, and thus the vehicle body sensor group particularly become closer to a distal end, a movement path amount become larger. Further, the blind area of the vehicle body sensor group 72 changes in time series.

Therefore, in the present embodiment, an arm sensor group 74 such as a small camera and LiDAR is attached to the distal end of each of the arms 62, 64, and 66 of each cart (the high-speed cart 52A and the local cart 52B). The arm sensor group 74 at the distal end of each of the arms 62, 64, and 66 can eliminate the blind area of the vehicle body sensor group 72 of the cart body.

Further, for example, by adding a temperature sensor, a hardness sensor, or the like as a type of arm sensor group 74 at the distal end of each of the arms 62, 64, and 66, it is possible to set a grip strength or the like during transfer (grip) of the basket 56. By setting the grip strength or the like, it is possible to prevent deformation and damage of the basket 56.

As the in-warehouse sensor group 70, the vehicle body sensor group 72, and the arm sensor group 74, a highest-performance camera, a solid-state LiDAR, a multi-color laser coaxial displacement meter, or any of various other sensor groups can be adopted. In addition, a vibratory meter, a thermo camera, a hardness meter, a radar, a LiDAR, a camera with high-pixel, telephoto, ultra-wide angle, 360 degrees, and high performance, vision recognition, a fine sound, an ultrasonic wave, vibration, an infrared ray, an ultraviolet ray, an electromagnetic wave, a temperature, humidity, spot AI weather forecast, high-accuracy multi-channel GPS, low-altitude satellite information, long tail incident AI data, and the like can be given as examples.

In addition to the above information, the in-warehouse sensor group 70, the vehicle body sensor group 72, and the arm sensor group 74 detect an image, a distance, vibration, heat, odor, color, sound, an ultrasonic wave, an ultraviolet ray, an infrared ray, or the like. In addition, examples of the information detected by the in-warehouse sensor group 70, the vehicle body sensor group 72, and the arm sensor group 74 include a movement of the center of gravity of the cart robot 52, detection of a material of the floor on which the cart robot 52 is installed, detection of an outside air temperature, detection of outside air humidity, detection of vertical and lateral oblique inclination angles of the floor, detection of a moisture amount, and the like. The in-warehouse sensor group 70, the vehicle body sensor group 72, and the arm sensor group 74 perform the detection, for example, every nanosecond.

In the present embodiment, the docking station 68 is provided on the floor 50 of the warehouse. However, for example, the docking station 68 may not be provided. In this case, the storage station 69 may be provided outside of a position corresponding to the docking station 68. Near the storage station 69, the exit lane 59A and an entrance lane 59B are provided similarly to the opposite sides.

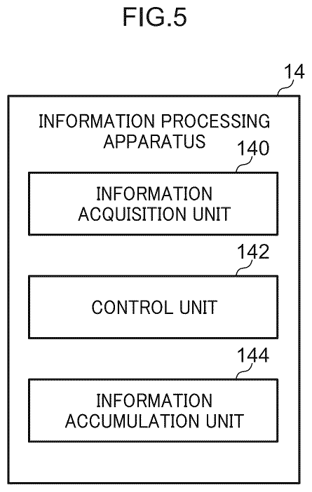

FIG. 5 is a block diagram illustrating a control system of the information processing apparatus 14 mounted on the cart robot 52. The information processing apparatus 14 includes an information acquisition unit 140, a control unit 142, and an information accumulation unit 144. The information acquisition unit 140 acquires information regarding objects detected by the vehicle body sensor group 72 and the arm sensor group 74.

The control unit 142 uses information acquired by the information acquisition unit 140 and artificial intelligence (AI) to control rotation operations of the arms 62, 64, and 66, a movement operation in the vertical direction, an operation of a grip portion at the distal end, and the like. The control unit 142 is an example of a picking control unit according to the present disclosure. For example, the control unit 142 executes each of the following processes.
(1) The arms 62, 64, and 66 and their distal grip portions are driven to be able to grip an object.
(2) The arms 62, 64, and 66 and their distal grip portions are driven up and down to match the height of a work table such as the storage unit 54.
(3) To prevent falling, balance is kept.
(4) Driving of wheels during movement is controlled.

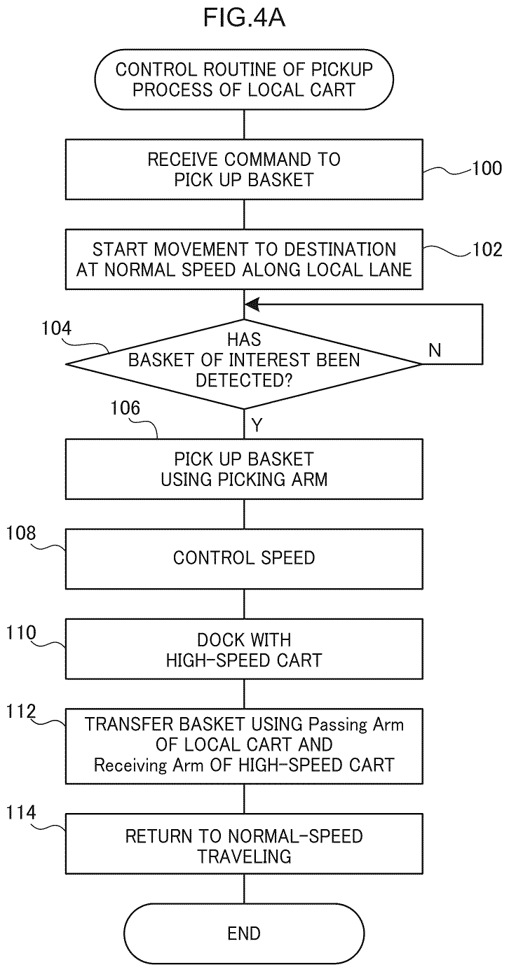

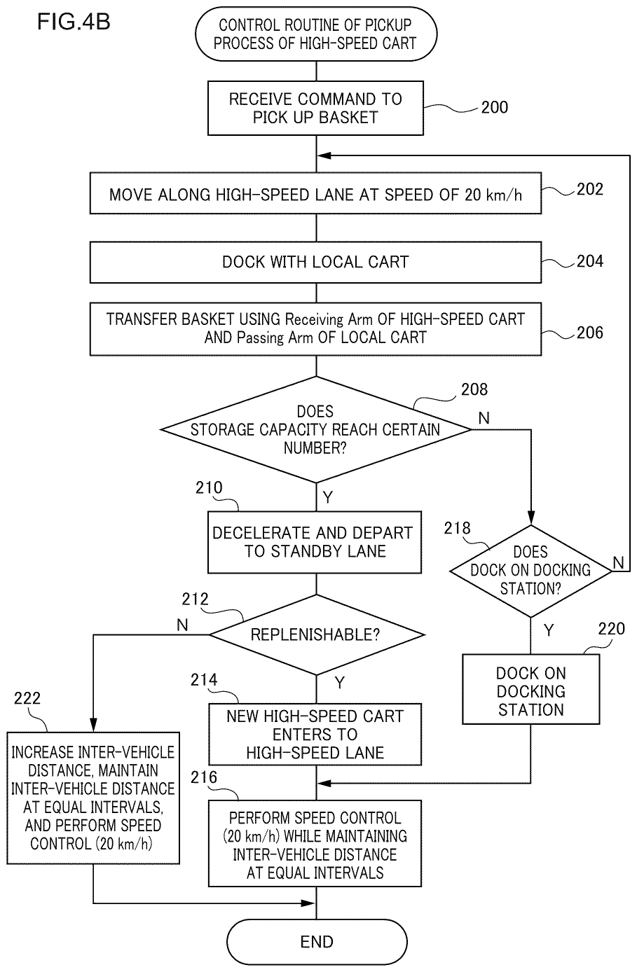

An operation according to the present embodiment will be described below with reference to a flowchart of FIG. 4A. FIG. 4 is a flowchart illustrating a pickup control process for the basket 56 by the local cart 52B. In step 100, a command to pick up the basket 56 is received. In subsequent step 102, movement to the destination is started at a normal speed along the local lane 60. In subsequent step 104, it is determined whether the basket 56 of interest has been detected. If Yes is determined, the process proceeds to step 106 and the basket 56 is picked up using the picking arm 62, and then the process proceeds to step 108. In step 108, the local cart moves at a control speed (for example, 20 km/h). Subsequently, the process proceeds to step 110 and the local cart approaches the high-speed cart 52A while meandering in a direction of the high-speed lane 58. In subsequent step 112, the passing arm 64 of the local cart 52B and the receiving arm 66 of the high-speed cart 52A transfer the basket 56 from the local cart 52B to the high-speed cart 52A. Then, the process proceeds to step 114. In step 114, the local cart 52B returns to normal-speed traveling, and this routine ends in order to wait for a subsequent command.

Hereinafter, an operation of the present embodiment will be described with reference to the flowchart of FIG. 4B. FIG. 4B is a flowchart illustrating a pickup control process of the basket 56 by the high-speed cart 52A. In step 200, a command to pick up the basket 56 is received. In subsequent step 202, the high-speed cart moves along the high-speed lane 58 at a speed of 20 km/h. In subsequent step 204, the high-speed cart docks with the local cart 52B. In subsequent step 206, the receiving arm 66 of the high-speed cart 52A and the passing arm 64 of the local cart 52B transfer the basket 56 from the local cart 52B to the high-speed cart 52A, and then the process proceeds to step 208.

In step 208, it is determined whether the storage amount reaches a certain level. If Yes is determined, the process proceeds to step 210, and the high-speed cart decelerates and departs to the standby lane 59. In step 212, it is determined whether the new high-speed cart 52A, that is, the high-speed cart 52A replacing the departing high-speed cart 52A can be supplied. If Yes is determined, the process proceeds to step 214, and the new high-speed cart 52A enters the high-speed lane 58. In step S216, each of the high-speed carts 52A is subjected to speed control (20 km/h) while maintaining an inter-vehicle distance at equal intervals, and travels along the high-speed lane 58.

Conversely, when No is determined in step 208, the process proceeds to step 218 to determine whether the high-speed cart can dock with the docking station 68. When Yes is determined, the process proceeds to step 220 to dock with the docking station 68. Then, the process proceeds to step 216. The high-speed cart 52A docks on the docking station 68 to take out the basket 56 in the storage unit 67.

Conversely, when No is determined in step S212, that is, the new high-speed cart 52A cannot be supplied, the process proceeds to step 222 and the inter-vehicle distance of each high-speed cart 52A is increased, the inter-vehicle distance is maintained at the equal intervals, speed control (20 km/h) is performed, and the vehicle travels along the high-speed lane 58. Since the high-speed cart 52A ends this routine in order to wait for a subsequent command.

Meanwhile, since the arms 62, 64, and 66 move in three dimensions based on work such as picking of the basket 56 and transferring between the carts, the arms may cross a monitoring area of the vehicle body sensor group 72 installed in the cart body, and a blind area may occur in any vehicle body sensor group 72. However, in the present embodiment, the arm sensor group 74 at the distal end of each of the arms 62, 64, and 66 can eliminate blind areas of the vehicle body sensor group 72 of the cart body. When the arm sensor group 74 at the distal end of each of the arms 62, 64, and 66 is a temperature sensor, a hardness sensor, or the like, a grip strength or the like can be adjusted during transferring (gripping) the basket 56, and thus it is possible to prevent deformation or damage of the basket 56.

### Second Embodiment

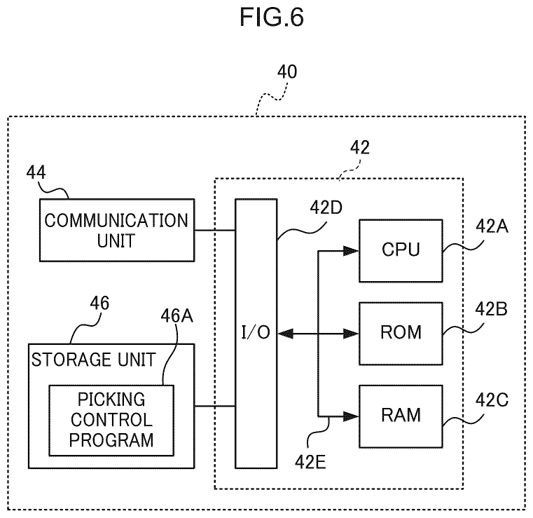

A second embodiment will be described. The same constituents as those of the first embodiment are denoted by the same reference numerals, and detailed description thereof will be omitted. In the second embodiment, a case where a picking control device generally controls the cart 52 and the like will be described. FIG. 6 is a block diagram illustrating a hardware configuration of a picking control device 40 according to the second embodiment. As illustrated in FIG. 6, the picking control device 40 includes a controller 42.

The controller 42 includes a central processing unit (CPU) 42A, a read only memory (ROM) 42B, a random access memory (RAM) 42C, and an input/output interface (I/O) 42D. The CPU 42A, the ROM 42B, the RAM 42C, and the I/O 42D are connected via a bus 42E. The bus 42E includes a control bus, an address bus, and a data bus. A communication unit 44 and a storage unit 46 are connected to the I/O 42D. Note that the CPU 42A is an example of a generation unit and a picking control unit. The communication unit 44 is an interface for performing data communication with an external device such as the high-speed cart 52A, the local cart 52B, the in-warehouse sensor group 70, the vehicle body sensor group 72, the arm sensor group 74, and a host apparatus (not illustrated). The storage unit 46 includes, for example, a nonvolatile memory. As illustrated in FIG. 6, the storage unit 46 stores a picking control program 46A and the like.

The CPU 42A is an example of a processor. Here, the processor is a processor in a broad sense, and includes a general-purpose processor (for example, a CPU) or a dedicated processor (for example, a graphics processing unit (GPU), an application specific integrated circuit (ASIC), a field programmable gate array (FPGA), a programmable logic device, and the like). The picking control program 46A may be appropriately installed in the picking control device 40 by being stored in a nonvolatile non-transitory recording medium or distributed via a network. Examples of the nonvolatile non-transitory recording medium include a compact disc read only memory (CD-ROM), a magneto-optical disc, a hard disk drive (HDD), a digital versatile disc read only memory (DVD-ROM), a flash memory, and a memory card.

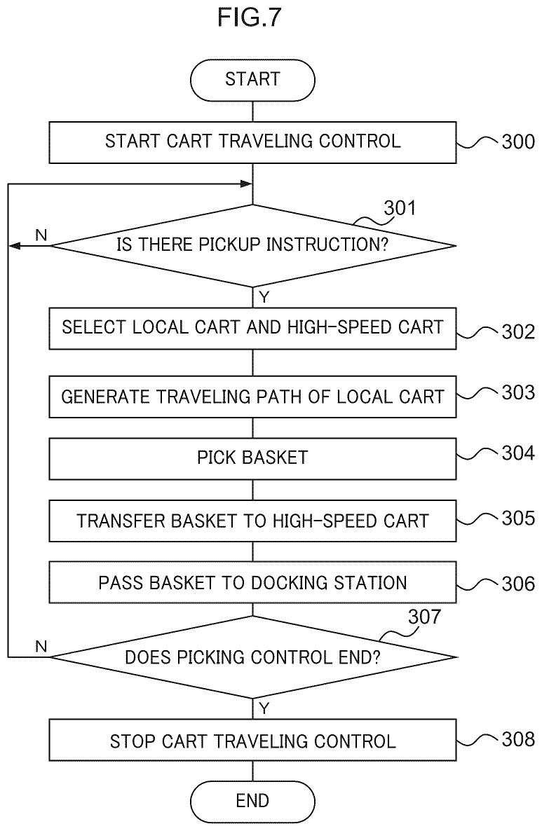

FIG. 7 is a flowchart of a picking control process executed by the CPU 42A. For example, when an instruction to execute the picking control process is given from the host apparatus (not illustrated), the CPU 42A executes the picking control process illustrated in FIG. 7 by reading and executing the picking control program 46A.

In step 300, the CPU 42A starts traveling control of the high-speed cart 52A and the local cart 52B. Specifically, the CPU 42A controls the plurality of high-speed carts 52A to travel in the clockwise direction in FIG. 1 at a predetermined speed along the high-speed lane 58 while maintaining the inter-vehicle distance at a constant distance. The CPU 42A controls the plurality of local carts 52B to travel in the clockwise direction in FIG. 1 at a predetermined speed in the local lane 60 meandering to approach and separate from the storage unit 54 while maintaining the inter-vehicle distance at a constant distance. The high-speed lane 58 and the local lane 60 are not physical traveling lanes, but indicate a path along which the cart 52 travels. That is, the CPU 42A controls the high-speed cart 52A to travel according to the path of the high-speed lane 58, and controls the local cart 52B to travel according to the path of the local lane 60.

In step 301, the CPU 42A determines whether a command to pick up the basket 56 is received from the host apparatus (not illustrated). The pickup command includes information such as a position and a size of the basket 56 to be picked up. The local cart 52B can accommodate the plurality of baskets 56 depending on the size of the baskets 56. Therefore, an instruction to pick up the plurality of baskets 56 is given from the host apparatus in some cases. In these cases, information such as the positions and sizes of the plurality of baskets 56 is included in the pickup command. When the instruction to pick up the baskets 56 is received from the host apparatus, the process proceeds to step S302. When the pickup instruction is not received, the process waits until the pickup instruction is received.

In step 302, the CPU 42A selects the local cart 52B to pick up the baskets 56 and the high-speed cart 52A to which the baskets 56 is to be transferred. For example, the position and the traveling speed of each high-speed cart 52A and each local cart 52B are calculated based on signals from the in-warehouse sensor group 70 and the vehicle body sensor group 72. Based on a calculation result, the local cart 52B capable of picking up the basket 56 to be picked up in a shortest time is selected from the plurality of local carts 52B. Based on the calculation result, the high-speed cart 52A capable of receiving the basket 56 in the shortest time from the selected local cart 52B is selected from the plurality of high-speed carts 52A. Hereinafter, the selected local cart 52B is referred to as a selected local cart 52B, and the selected high-speed cart 52A is referred to as a selected high-speed cart 52A. When an instruction to pick up the plurality of baskets 56 is given, the high-speed cart 52A is selected for each of the plurality of baskets 56.

In step 303, the CPU 42A generates a traveling path of the selected local cart 52B. Specifically, the traveling path of the selected local cart 52B is generated based on the position of the basket 56 to be picked up by the selected local cart 52B and the position of the selected high-speed cart 52A to which the basket 56 picked up by the selected local cart 52B is to be transferred. For example, the traveling path is generated such that a time until the basket 56 is moved to the position of the basket 56 and the basket 56 is picked up and transferred to the selected high-speed cart 52A is minimized. When the instruction to pick up the plurality of baskets 56 is given, the plurality of baskets 56 are sequentially transferred to the plurality of selected high-speed carts 52A. Therefore, the traveling path of the selected local cart 52B is generated based on an order of transferring the plurality of baskets 56 to the plurality of selected high-speed carts 52A. Since a position at which the basket 56 is transferred to the selected high-speed cart 52A varies depending on the size of the basket 56, a traveling path of the selected local cart 52B is generated based on the size of the basket 56.

In step 304, the CPU 42A controls the selected local cart 52B such that the selected local cart 52B travels along the traveling path generated in step 303 and picks up the basket 56. Specifically, the selected local cart 52B performs control such that the basket 56 is picked up using the picking arm 62.

In step 305, the CPU 42A controls the selected local cart 52B and the high-speed cart 52A such that the selected local cart 52B travels along the traveling path generated in step 303 and transfers the picked basket 56 to the selected high-speed cart 52A. Specifically, the local cart 52B controls the picking arm 62 and the passing arm 64 of the selected local cart 52B and controls the receiving arm 66 of the selected local cart 52B such that the basket 56 picked by the picking arm 62 is lifted by the passing arm 64 to be transferred to the receiving arm 66 of the high-speed cart 52A.

At this time, the CPU 42A performs control such that the basket 56 is transferred from the selected high-speed cart 52A to the selected high-speed cart 52A, by setting a position at which the speeds of the selected local cart 52B and the selected high-speed cart 52A become equal and a distance between the selected local cart 52B and the selected high-speed cart 52A is minimum as the transfer position. The transfer position is a position within a range in which a movement range of the passing arm 64 of the selected local cart 52B overlaps a movement range of the receiving arm 66 of the selected high-speed cart 52A.

In step 306, the CPU 42A controls the selected high-speed cart 52A such that the selected high-speed cart 52A receiving the basket 56 passes the basket 56 to the docking station 68. In step 307, the CPU 42A determines whether the picking control of the basket 56 ends. Specifically, it is determined whether there is an instruction to end the picking control from the host apparatus (not illustrated). Then, when there is an instruction to end the picking control, the process proceeds to step 308. When there is no instruction to end the picking control, the process returns to step 301 and a process similar to the above process is repeated. In step 308, the CPU 42A stops the traveling control of the high-speed cart 52A and the local cart 52B and stops the high-speed cart 52A and the local cart 52B.

As described above, in the present embodiment, the picking control device 40 controls the traveling of the high-speed cart 52A and the local cart 52B. Then, a traveling path of the selected local cart 52B is generated based on the position of the basket 56 to be picked up by the selected local cart 52B and the position of the selected high-speed cart 52A to which the basket 56 picked up by the selected local cart 52B is to be transferred. The selected local cart 52B picks up the basket 52 using the picking arm 62 while traveling along the local lane 60 and transfers the basket to the selected high-speed cart 52A based on the generated traveling path. The selected high-speed cart 52A is controlled to receive the basket 52 picked up by the selected local cart 52B using the receiving arm 66 while traveling along the high-speed lane 58 and carry the basket 56 to the docking station 68. Accordingly, the basket 56 can be efficiently picked up and conveyed to the docking station 68.

### Third Embodiment

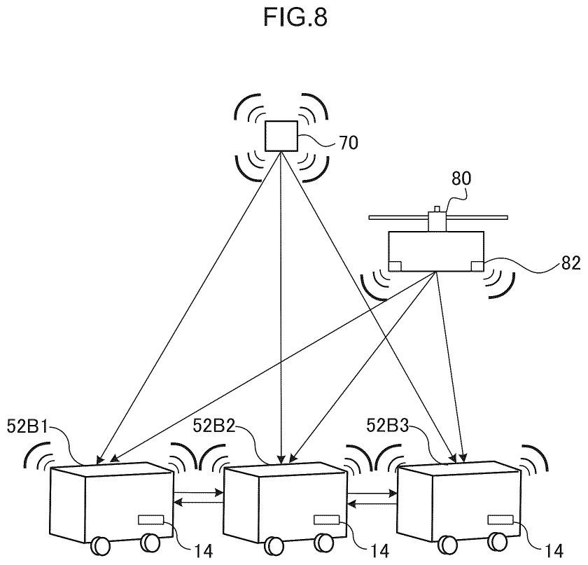

FIG. 8 is a diagram illustrating an example of a configuration of a conveying system according to a third embodiment of the disclosed technology. In the conveying system according to the present embodiment, the cart robot 52 acquires sensor information of other surrounding cart robots 52, sensor information of the floor 50, and sensor information from the drone 80 to travel. Hereinafter, differences from the first embodiment will be described. The same constituents are denoted by the same reference numerals, and detailed description thereof will be omitted.

The cart robot 52 according to the present embodiment includes a camera-dedicated cart on which only a camera is mounted as a sensor acquiring an external environment among the vehicle body sensor group 72, and a LiDAR-dedicated cart on which only a LiDAR is mounted as a sensor acquiring an external environment. Examples of the camera-dedicated cart include a camera-dedicated cart 52A1 which is the high-speed cart 52A on which only a visible light camera is mounted, a camera-dedicated cart 52B1 which is a local cart 52B, a camera-dedicated cart 52A3 which is a high-speed cart 52A on which only an IR camera is mounted, and a camera-dedicated cart 52B3 which is a local cart 52B as illustrated in FIG. 1. The LiDAR-dedicated cart includes, for example, a LiDAR-dedicated cart 52A2 which is a high-speed cart 52A on which only a LiDAR is mounted and a LiDAR-dedicated cart 52B2 which is a local cart 52B as illustrated in FIG. 1.

The cart robot 52 according to the present embodiment may also acquire sensor information of the in-warehouse sensor group 70 on the floor 50 illustrated in FIG. 1. Specifically, the in-warehouse sensor group 70 is disposed on a wall or a ceiling of the warehouse where the cart robot 52 travels, and the cart robot 52 acquires sensor information of the floor 50 detected by the in-warehouse sensor group 70.

Further, the cart robot 52 according to the present embodiment may also acquire sensor information from the sensor 82 mounted on the drone 80. Specifically, the drone 80 includes a body, a flight apparatus, a sensor 82 (see FIG. 8) serving as a detection device, and a control device, and the control device can make a travel plan and fly autonomously using sensor information acquired by the sensor 82. Further, the drone 80 can transmit the acquired sensor information of the sensor 82 to the cart robot 52. The cart robot 52 can travel using the sensor information of the sensor 82 received from the drone 80. Here, the drone 80 is an example of a flight vehicle.

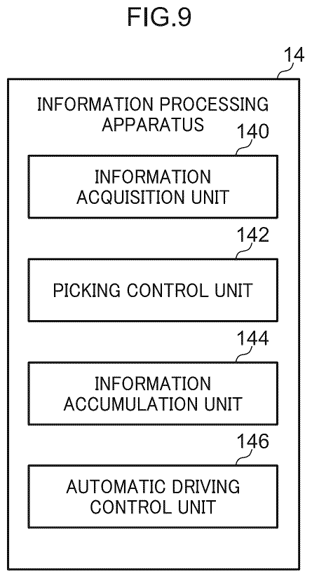

FIG. 9 is a functional block diagram illustrating the information processing apparatus 14 according to the second embodiment. The information processing apparatus 14 is mounted on the cart robot 52. The information processing apparatus 14 according to the present embodiment includes an automatic driving control unit 146 in addition to the information acquisition unit 140, the picking control unit 142, and the information accumulation unit 144.

The automatic driving control unit 146 prepares the travel plan of the cart robot 52 and performs automatic driving using the sensor information acquired by the information acquisition unit 140. Specifically, the information acquisition unit 140 acquires sensor information of another cart robot 52 that is near the cart robot 52 in addition to the sensor information of the own cart robot 52. Here, the nearby presence of the cart robot 52 is not limited to the case of presence adjacent to the cart robot 52, and includes a case of presence on the same floor and a case of presence within a predetermined range. The automatic driving control unit 146 controls autonomous traveling of the cart robot 52 in accordance with the travel plan of the cart robot 52 based on the acquired sensor information. Since the cart robot 52 can acquire sensor information of other cart robots 52 that are present nearby, the number of sensors mounted on the cart robot 52 is minimized. Further, the automatic driving control unit 146 may also use the sensor information of the floor 50 acquired by the information acquisition unit 140. Accordingly, more detailed movement can be controlled in the automatic driving of the cart robot 52. Further, the automatic driving control unit 146 may also use sensor information from the sensor 82 of the drone 80 acquired by the information acquisition unit 140. Accordingly, a blind area can be eliminated in the automatic driving of the cart robot 52.

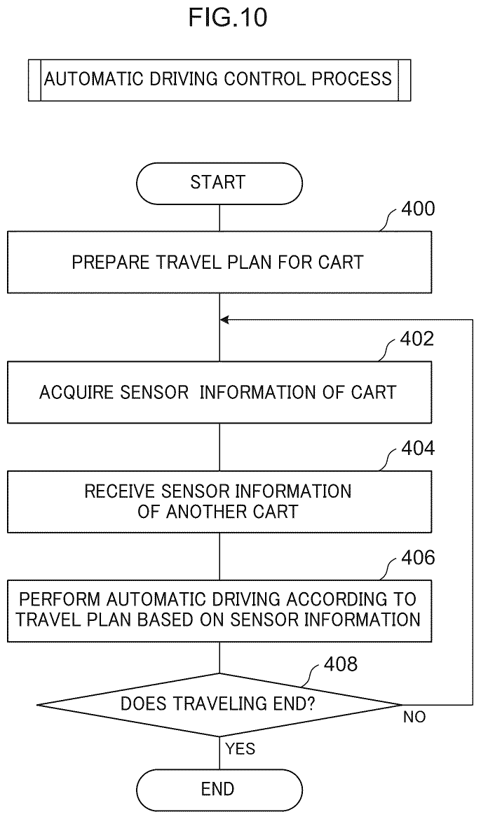

Hereinafter, an operation of the information processing apparatus 14 according to the present embodiment will be described. In the information processing apparatus 14, an automatic driving control process illustrated in FIG. 10 is executed. A process in the information processing apparatus 14 is executed by the CPU 1212 that functions as the information acquisition unit 140, the picking control unit 142, the information accumulation unit 144, and the automatic driving control unit 146. FIG. 10 is a flowchart illustrating the automatic driving control process of the cart robot 52. In this flowchart, a case where the cart robot 52 is the camera-dedicated cart 52B1 will be exemplified.

In step 400, the CPU 1212 prepares the travel plan for the camera-dedicated cart 52B1. In step 402, the CPU 1212 acquires the sensor information of the camera-dedicated cart 52B1. Specifically, the camera-dedicated cart 52B acquires the sensor information from the visible light camera mounted on the own cart. The sensor information of the in-warehouse sensor group 70 on the floor 50 and sensor information from the sensor 82 mounted on the drone 80 may also be acquired. The sensor information is detected, for example, every nanosecond.

In step 404, the CPU 1212 receives sensor information of another cart. The other cart is specifically the other cart robot 52 that is near the camera-dedicated cart 52B1 and is, for example, the LiDAR-dedicated cart 52B2 or the camera-dedicated cart 52B3 as illustrated in FIG. 8. Another cart that is nearby may be a cart on which a visible light camera is mounted, similarly to the camera-dedicated cart 52B1, and may be, for example, a cart on which a visible light camera with higher accuracy than the camera-dedicated cart 52B1 is mounted. For example, a highly accurate visible light camera may be mounted on the camera-dedicated cart 52B1, and a lower accuracy visible light camera may be mounted on another cart that is nearby. As described above, since the sensor information of the other cart robot 52 that is near the own cart can also be received, the number of sensors mounted on the own cart can be minimized.

In step 406, the CPU 1212 performs automatic driving according to the travel plan of the camera-dedicated cart 52B1 based on the sensor information. For example, a traveling speed of the camera-dedicated cart 52B1 is adjusted in accordance with a movement of the high-speed cart 52A traveling in parallel. In step 408, the CPU 1212 determines whether to end the traveling of the camera-dedicated cart 52B1. When the CPU 1212 determines that the traveling of the camera-dedicated cart 52B1 has not ended (No in step 408), the process proceeds to step 402. Conversely, when the CPU 1212 determines that the traveling of the camera-dedicated cart 52B1 has ended (YES in step 408), the process ends. The case where the CPU 1212 determines that the traveling has ended includes a case where the traveling according to the travel plan prepared by the camera-dedicated cart 52B1 has ended and a case where the camera-dedicated cart 52B1 has run out of charge.

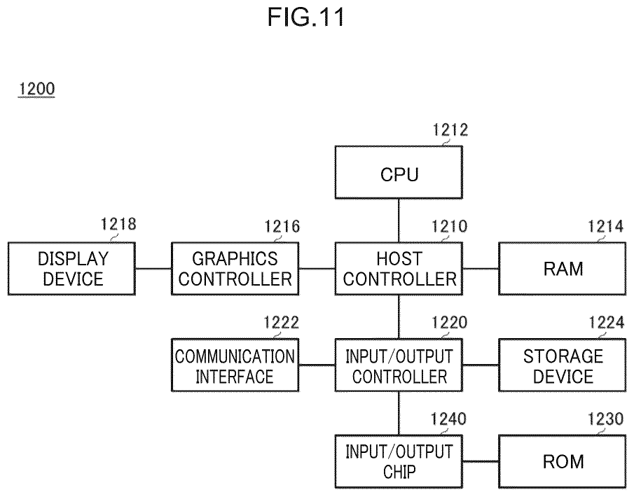

(Embodiment of Information Processing Apparatus 14 of Cart Robot 52) FIG. 11 schematically illustrates an example of a hardware configuration of a computer 1200 that functions as the information processing apparatus 14. A program installed on the computer 1200 can cause the computer 1200 to function as one or more “units” of the apparatus according to the present embodiment, or cause the computer 1200 to execute an operation associated with the apparatus according to the present embodiment or one or more “units” thereof, and/or cause the computer 1200 to execute a process according to the present embodiment or a stage of the process. The program may be executed by the CPU 1212 to cause the computer 1200 to perform specific operations associated with some or all of the blocks in the flowcharts and block diagrams described herein.

The computer 1200 according to the present embodiment includes a CPU 1212, a RAM 1214, and a graphics controller 1216 connected to each other by a host controller 1210. The computer 1200 also includes an input/output unit such as a communication interface 1222, a storage device 1224, a DVD drive, or an IC card drive connected to the host controller 1210 via an input/output controller 1220. The DVD drive may be a DVD-ROM drive, a DVD-RAM drive, or the like. The storage device 1224 may be a hard disk drive, a solid state drive, or the like. The computer 1200 also includes an input/output unit such as a ROM 1230 and a keyboard connected to the input/output controller 1220 via an input/output chip 1240.

The CPU 1212 operates according to a program stored in the ROM 1230 and the RAM 1214 to control each unit. The graphics controller 1216 acquires image data generated by the CPU 1212 in a frame buffer or the like provided in the RAM 1214 or itself and causes the image data to be displayed on the display device 1218.

The communication interface 1222 communicates with other electronic apparatuses via a network. The storage device 1224 stores programs and data used by the CPU 1212 in the computer 1200. The DVD drive reads a program or data from a DVD-ROM or the like and provides the program or the data to the storage device 1224. The IC card drive reads programs and data from and/or writes the programs and the data to the IC card.

The ROM 1230 stores a boot program or the like executed by the computer 1200 during activation and/or a program dependent on hardware of the computer 1200. The input/output chip 1240 may also connect various input/output units to the input/output controller 1220 via a USB port, a parallel port, a serial port, a keyboard port, a mouse port, or the like.

The program is provided by a computer-readable storage medium such as a DVD-ROM or an IC card. The program is read from a computer-readable storage medium, is installed on the storage device 1224, the RAM 1214, or the ROM 1230 that is also an example of a computer-readable storage medium, and executed by the CPU 1212. Information processing described in the program is read by the computer 1200 and provides cooperation between the program and any of various types of hardware resources. An apparatus or a method may be configured by implementing an operation or processing on information according to use of the computer 1200.

For example, when communication is performed between the computer 1200 and an external device, the CPU 1212 may execute a communication program loaded in the RAM 1214 and instruct the communication interface 1222 to perform communication processing based on processing described in the communication program. Under the control of the CPU 1212, the communication interface 1222 reads transmission data stored in a transmission buffer area provided in a recording medium such as the RAM 1214, the storage device 1224, a DVD-ROM, or an IC card, transmits the read transmission data to a network, or writes reception data received from the network to a reception buffer area or the like provided on the recording medium.

The CPU 1212 may cause the RAM 1214 to read all or necessary portions of a file or database stored in an external recording medium such as the storage device 1224, a DVD drive (DVD-ROM), an IC card, or the like, and may execute various processes on data on the RAM 1214. Next, the CPU 1212 may write back the processed data on the external recording medium.

Various types of information such as various types of programs, data, tables, and databases may be stored in a recording medium and may be subjected to information processing. The CPU 1212 may execute various processes on the data read from the RAM 1214, including various types of operations, information processing, condition determination, conditional branching, unconditional branching, information retrieval/replacement, and the like, which are described throughout the present disclosure and specified by a command sequence of a program, and writes back results on the RAM 1214. The CPU 1212 may search for information in a file, a database, or the like in the recording medium. For example, when a plurality of entries each having the attribute value of the first attribute associated with the attribute value of the second attribute are stored in the recording medium, the CPU 1212 may search for an entry in which the attribute value of the first attribute matches the specified condition from the plurality of entries, read the attribute value of the second attribute stored in the entry, and thus acquire the attribute value of the second attribute associated with the first attribute satisfying a predetermined condition.

A program or software module described above may be stored in a computer-readable storage medium on the computer 1200 or near the computer 1200. A recording medium such as a hard disk or a RAM provided in a server system connected to a dedicated communication network or the Internet can be used as a computer-readable storage medium, and thus a program is provided to the computer 1200 via the network.

The blocks in the flowcharts and the block diagrams in the above embodiments may represent steps of the processes in which operations are performed or “units” of the apparatuses that are responsible for performing the operations. Certain stages and “units” may be implemented by a dedicated circuit, a programmable circuit provided along with computer-readable instructions stored on a computer-readable storage medium, and/or a processor provided along with computer-readable instructions stored on a computer-readable storage medium. Dedicated circuits may include digital and/or analog hardware circuits and may include integrated circuits (ICs) and/or discrete circuits. The programmable circuits may include reconfigurable hardware circuits including, for example, logical conjunction, logical disjunction, exclusive OR, NAND, NOR, and other logical operations, flip-flops, registers, and memory elements, such as field programmable gate arrays (FPGAs) and programmable logic arrays (PLAs).

A computer-readable storage medium may include any tangible device capable of storing instructions for execution by a suitable device, such that a computer-readable storage medium having instructions stored thereon includes an article of manufacture including instructions that may be executed to create means for performing the operations specified in the flowcharts or block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-Ray disk, a memory stick, and an integrated circuit card.

The computer-readable instructions may include either source codes or object codes written in any combination of one or more programming languages, including assembler instructions, instruction set architecture (ISA) instructions, machine instructions, machine-dependent instructions, microcode, firmware instructions, state-setting data, or an object-oriented programming language such as Smalltalk (registered trademark), JAVA (registered trademark), C++, or the like, and known procedural programming languages, such as the “C” programming language or a similar programming language.

The computer-readable instructions may be provided to a processor of a general purpose computer, a special purpose computer, or another programmable data processing apparatus, or a programmable circuit, via either locally or over a local area network (LAN) or a wide area network (WAN) such as the Internet, or the like, to cause the processor or the programmable circuit of the general purpose computer, the special purpose computer, or the other programmable data processing apparatus to execute the computer-readable instructions to generate means for the processor or programmable circuit to perform the operations specified in the flowcharts or block diagrams. Examples of the processor include a computer processor, a processing unit, a microprocessor, a digital signal processor, a controller, and a microcontroller.

Although the present invention has been described using the embodiments, the technical scope of the present invention is not limited to the scope described in the above embodiments. It is apparent to those skilled in the art that various modifications or improvements can be made to the above embodiments. It is apparent from the description of the claims that a mode to which such a change or improvement is added can also be included in the technical scope of the present invention.

It should be noted that the order of execution of each processing such as operations, procedures, steps, and stages in the devices, systems, programs, and methods illustrated in the claims, the specification, and the drawings may be implemented in any order unless “before”, “prior to”, or the like is specifically stated, and unless the output of the previous processing is used in the later processing. Even when the operation flow in the claims, the specification, and the drawings are described using “first,” “subsequently,” and the like for convenience, it does not mean that it is essential to perform operations in this order.

The disclosures of the Japanese patent applications listed below are incorporated herein by reference in their entirety. All documents, patent applications, and technical standards described in the present specification are incorporated herein by reference to the same extent as if each document, patent application, and technical standard were specifically and individually described to be incorporated by reference.
Japanese Patent Application No. 2022-168242 filed on Oct. 20, 2022
Japanese Patent Application No. 2022-188746 filed on Nov. 25, 2022
Japanese Patent Application No. 2022-188747 filed on Nov. 25, 2022
Japanese Patent Application No. 2022-193778 filed on Dec. 2, 2022
Japanese Patent Application No. 2022-212507 filed on Dec. 28, 2022

### DESCRIPTION OF REFERENCE NUMERALS

14 Information processing apparatus
50 Floor
52 Cart robot
54 Storage unit
52A High-speed cart
52B Local cart
56 Basket
58 High-speed lane
59 Standby lane
60 Local lane
62 Picking arm
64 Passing arm
66 Receiving arm
67 Storage unit
68 Docking station
70 In-warehouse sensor group
72 Vehicle body sensor group
74 Arm sensor group
80 Drone
82 Sensor
1200 Computer
1210 Host controller
1212 CPU
1214 RAM
1216 Graphics controller
1218 Display device
1220 Input/output controller
1222 Communication interface
1224 Storage device
1230 ROM
1240 Input/output chip

1. A picking system comprising:
a first cart including a first arm and traveling along a first lane set outside of an accommodation unit that accommodates a load;
a second cart including a second arm and traveling along a second lane set outside of the first lane; and
a processor configured to perform control such that the first cart picks up the load using the first arm and transfers the load to the second cart while traveling along the first lane, and the second cart receives the load picked up by the first cart using the second arm and carries the load to a predetermined position while traveling along the second lane.

2. The picking system according to claim 1, wherein the processor performs control such that the load is transferred from the first cart to the second cart while the first cart and the second cart are traveling parallel to each other.

3. The picking system according to claim 1, wherein the processor is further configured to
generate a traveling path of the first cart based on a position of the load to be picked up by the first cart and a position of the second cart to which the load picked up by the first cart is to be transferred, and
wherein, based on the traveling path, the processor performs control such that the first cart picks up the load using the first arm and transfers the load to the second cart while traveling along the first lane, and the second cart receives the load picked up by the first cart using the second arm and carries the load to a predetermined position while traveling along the second lane.

4. The picking system according to claim 3, wherein the processor generates the traveling path based on an order of transferring the load to the second cart.

5. The picking system according to claim 3, wherein the processor generates the traveling path based on a size of the load.

6. The picking system according to claim 2, wherein the processor performs control such that the load is transferred from the first cart to the second cart by setting a position at which speeds of the first cart and the second cart become equal and a distance between the first cart and the second cart is minimum as a transfer position.

7. The picking system according to claim 6, wherein the transfer position is a position within a range in which a movement range of the first arm overlaps a movement range of the second arm.

8. The picking system according to claim 1,
wherein the second cart includes a storage unit, and
wherein the processor performs control such that the first cart picks up the load using the first arm while traveling along the first lane and transfers the load to the second cart, the second cart receives the load picked up by the first cart using the second arm while traveling along the second lane and stores the load in the storage unit, and when a storage amount of the storage unit reaches a certain level, the second cart departs from the second lane and a new second cart is supplied.

9. The picking system according to claim 8,
wherein, when a plurality of the second carts travels along the second lane at equal intervals and the new second cart cannot be supplied, the processor performs control to increase an inter-vehicle distance of each of the plurality of the second carts and cause the plurality of the second carts to travel at equal intervals.

10. A picking control device comprising:
a processor configured to perform control such that a first cart including a first arm and traveling along a first lane set outside of an accommodation unit that accommodates a load picks up the load using the first arm while traveling along the first lane and transfers the load to a second cart, and a second cart including a second arm and traveling along a second lane set outside of the first lane receives the load picked up by the first cart using the second arm while traveling along the second lane and carries the load to a predetermined position.

11. The picking control device according to claim 10, wherein the processor is further configured to
generate a traveling path of the first cart based on a position of the load to be picked up by the first cart and a position of the second cart to which the load picked up by the first cart is to be transferred, and
wherein the processor performs control based on the traveling path such that the first cart picks up the load using the first arm and transfers the load to the second cart while traveling along the first lane, and the second cart receives the load picked up by the first cart using the second arm and carries the load to a predetermined position while traveling along the second lane.

12. The picking control device according to claim 10, wherein the processor performs control such that a second cart including a storage unit receives the load picked up by the first cart using the second arm while traveling along the second lane and stores the load in the storage unit, and when a storage amount of the storage unit reaches a certain level, the second cart departs from the second lane and a new second cart is supplied.

13. (canceled)

14. (canceled)

15. (canceled)

16. (canceled)

17. (canceled)

18. A non-transitory computer-readable storage medium storing a picking control program causing a computer to perform a process including control performed such that a first cart including a first arm and traveling along a first lane set outside of an accommodation unit that accommodates a load picks up the load using the first arm while traveling along the first lane and transfers the load to a second cart, and a second cart including a second arm and traveling along a second lane set outside of the first lane receives the load picked up by the first cart using the second arm while traveling along the second lane and carries the load to a predetermined position.

19. The non-transitory computer-readable storage medium according to claim 18, wherein the picking control program causing the computer to perform a process including control performed such that
a traveling path of the first cart is generated based on a position of the load to be picked up by the first cart and a position of the second cart to which the load picked up by the first cart is to be transferred, and
such that the first cart picks up the load using the first arm and transfers the load to the second cart while traveling along the first lane based on the traveling path, and the second cart receives the load picked up by the first cart using the second arm and carries the load to a predetermined position while traveling along the second lane.

20. The non-transitory computer-readable storage medium according to claim 18, wherein the picking control program causing the computer to perform a process including control performed such that
the first cart picks up the load using the first arm and transfers the load to the second cart while traveling along the first lane, the second cart having a storage unit receives the load picked up by the first cart using the second arm while traveling along the second lane and stores the load in the storage unit, and when a storage amount of the storage unit reaches a certain level, the second cart departs from the second lane and a new second cart is supplied.

21. (canceled)

22. (canceled)
